(19) United States
(12) Patent Application Publication
(10) Pub. No.: US 2009/0076936 A1
(43) Pub. Date: Mar. 19, 2009

(54) Dynamic Media Rights

(75) Inventor: Steven Allan Wright, Roswell, GA (US)

Correspondence Address: AT&T Legal Department;Attn: Patent Docketing, One AT&T Way, Room 2A-207, Bedminster, NJ, 07921, US

(73) Assignee: AT&T BLS INTELLECTUAL PROPERTY, INC., Wilmington, DE (US)

(21) Appl. No.: 11/854,782

(22) Filed: Sep. 13, 2007

(51) Int. Cl. G06Q 30/00

(52) U.S. Cl. 705/34

(57) ABSTRACT

Included are embodiments for providing dynamic media rights. At least one embodiment includes receiving content from at least one uploading user and determining at least one attribute associated with the content. Some embodiments include determining at least one compensation schedule for providing the content to at least one content consumer and providing an option to compensate the at least one uploading user, according to the compensation schedule, for providing the content to the at least one content consumer, wherein the compensation schedule is determined from the at least one attribute.

### TECHNICAL FIELD

This application relates to dynamic media rights. More specifically, this application relates to providing content to consumers.

### BACKGROUND

As the Internet has evolved, users have been provided with the ability to view content from a web page. More specifically, various websites have been created to provide image content, audio content, video content, etc. to consumers. In visiting these sites, consumers can view the available content and/or download the content for personal use. Similarly, some websites include options for users to upload content. The content may then be available to consumers to view and/or download.

While these websites have become popular, problems arise in compensating users for uploading of their content. Similarly, structured compensation to consumers for viewing and/or downloading content by others has also been difficult to achieve.

### SUMMARY

Included are embodiments for providing dynamic media rights. At least one embodiment includes receiving content from at least one uploading user and determining at least one attribute associated with the content. Some embodiments include determining at least one compensation schedule for providing the content to at least one content consumer and providing an option to compensate the at least one uploading user, according to the compensation schedule, for providing the content to the at least one content consumer.

Also included is a system for providing dynamic media rights. At least one embodiment of a system includes a receiving component configured to receive content from at least one uploading user and a first determining component configured to determine at least one attribute associated with the content. Some embodiments include a second determining component configured to determine at least one compensation schedule for providing the content to at least one content consumer; and a providing component configured to provide an option to compensate the at least one uploading user, according to the compensation schedule, for providing the content to the at least one content consumer.

Also included are embodiments of a computer readable storage medium for providing dynamic media rights. At least one embodiment includes receiving logic configured to receive content from at least one uploading user and first determining logic configured to determine at least one attribute associated with the content. Some embodiments include second determining logic configured to determine at least one compensation schedule for providing the content to at least one content consumer and providing logic configured to provide an option to compensate the at least one uploading user, according to the compensation schedule, for providing the content to the at least one content consumer.

Other systems, methods, features, and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

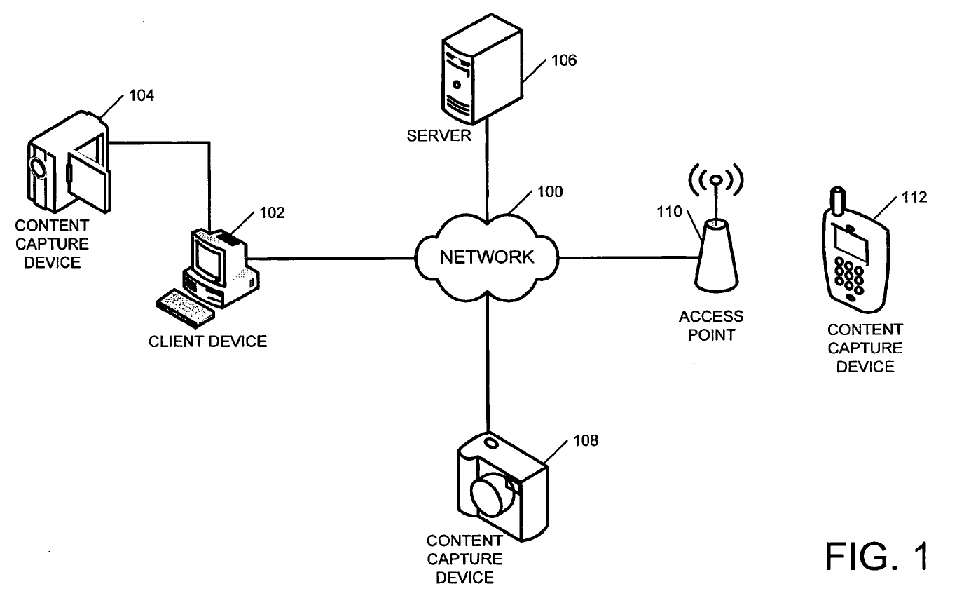

FIG. 1 illustrates a nonlimiting example of communications network, which may be configured to facilitate communication of content.

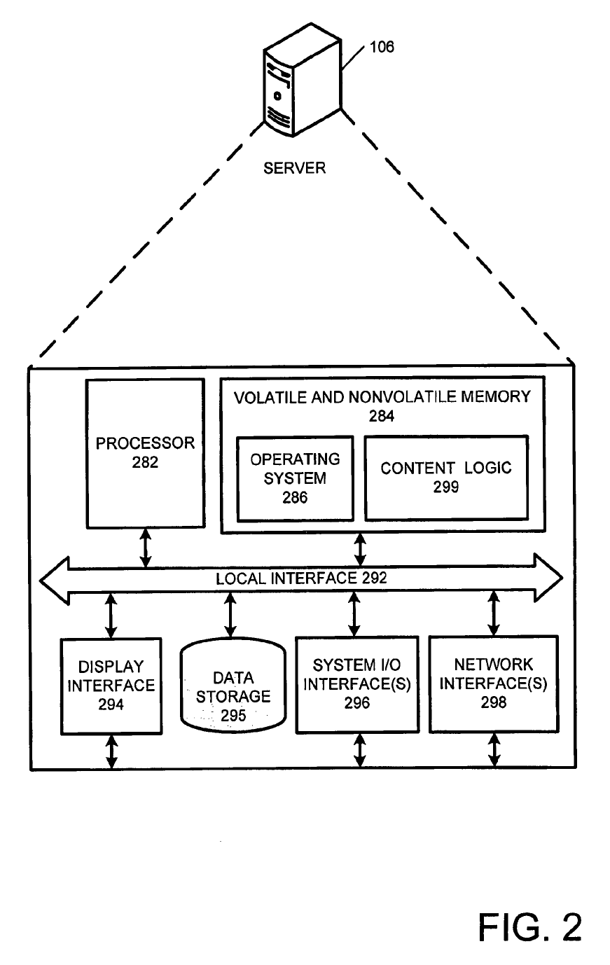

FIG. 2 illustrates a nonlimiting example of a server, which may be configured to provide options for uploading and/or downloading content, such as in the network from FIG. 1.

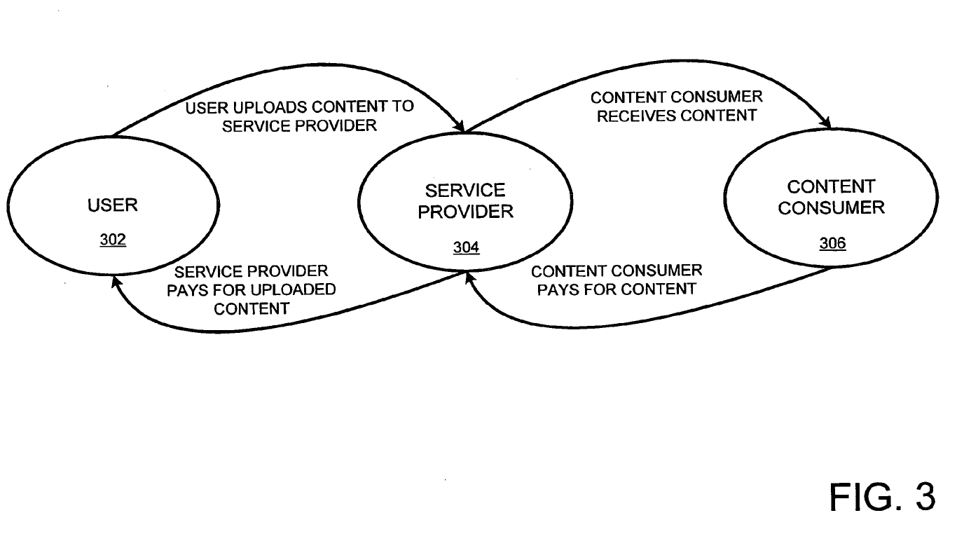

FIG. 3 is a flow diagram illustrating a nonlimiting example of interactions among an uploading user, a service provider, and a content consumer, such as in the network from FIG. 1.

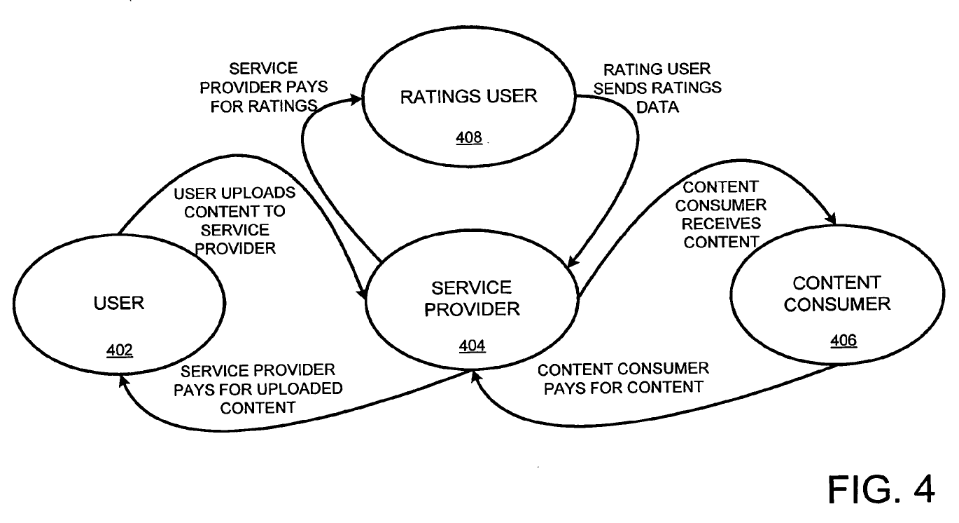

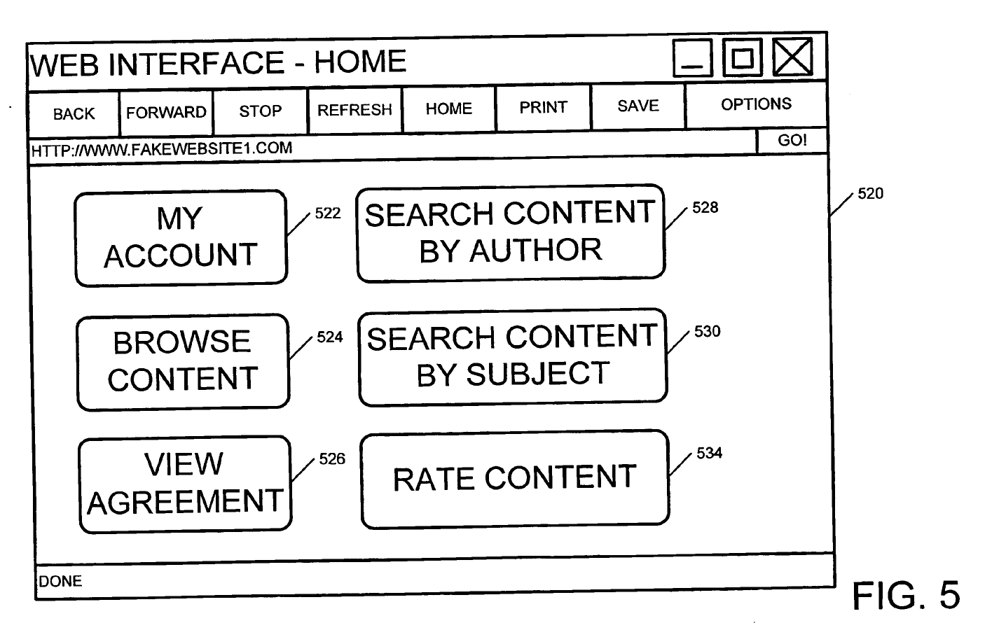

FIG. 4 is a flow diagram illustrating a nonlimiting example of interactions among an uploading user, a service provider, a content consumer, and a ratings user, similar to the diagram from FIG. 3.

FIG. 5 illustrates a nonlimiting example of a user interface for providing content to a consumer, such as in the network from FIG. 1.

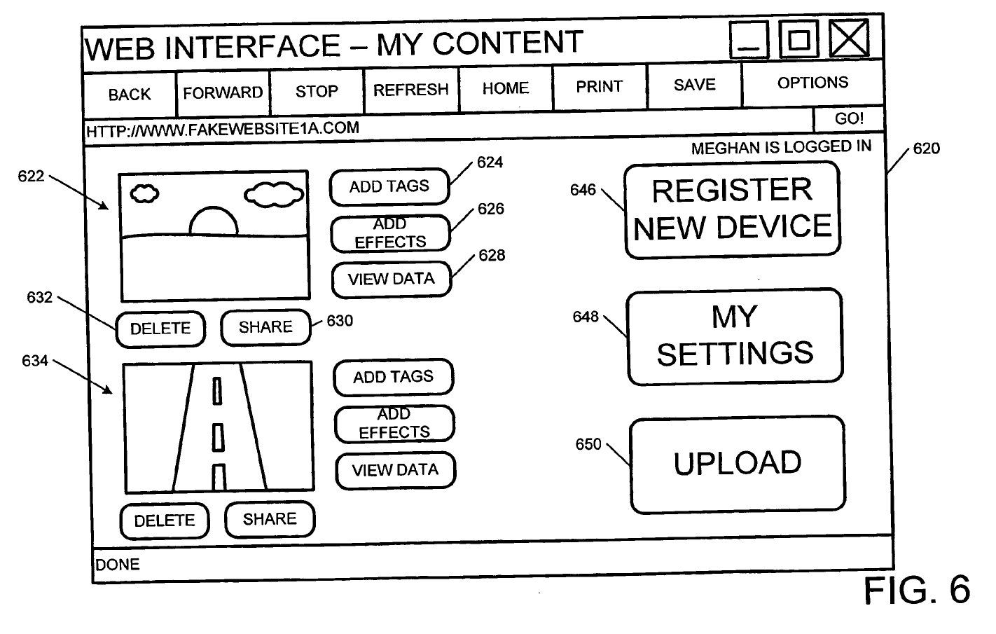

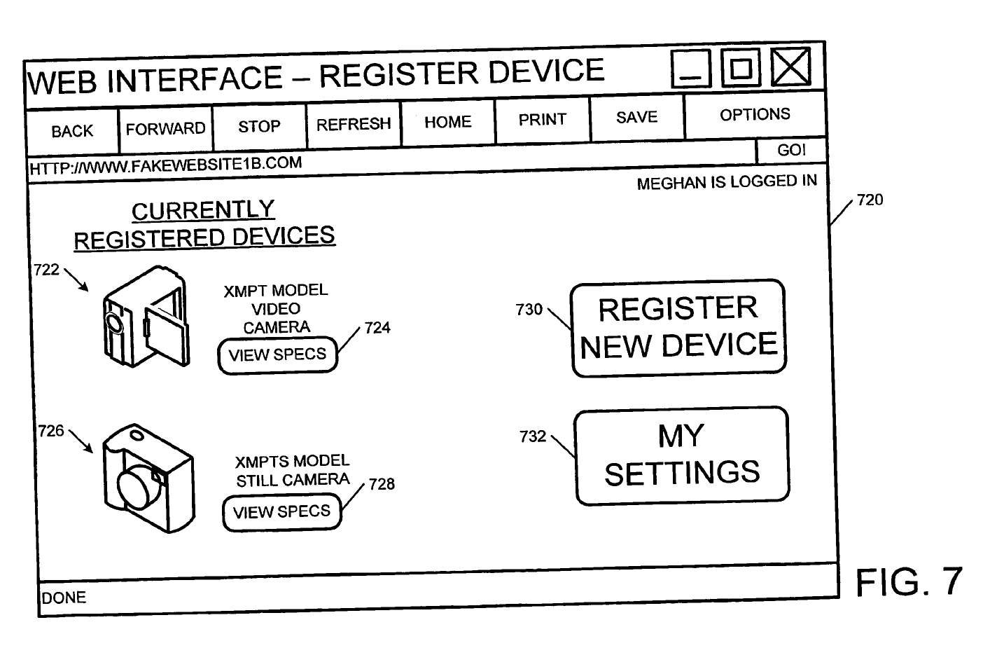

FIG. 6 illustrates a nonlimiting example of a user interface for providing uploaded content to a user, similar to the interface from FIG. 5.

FIG. 7 illustrates a nonlimiting example of a user interface for providing currently registered devices to a user, similar to the diagram from FIG. 6.

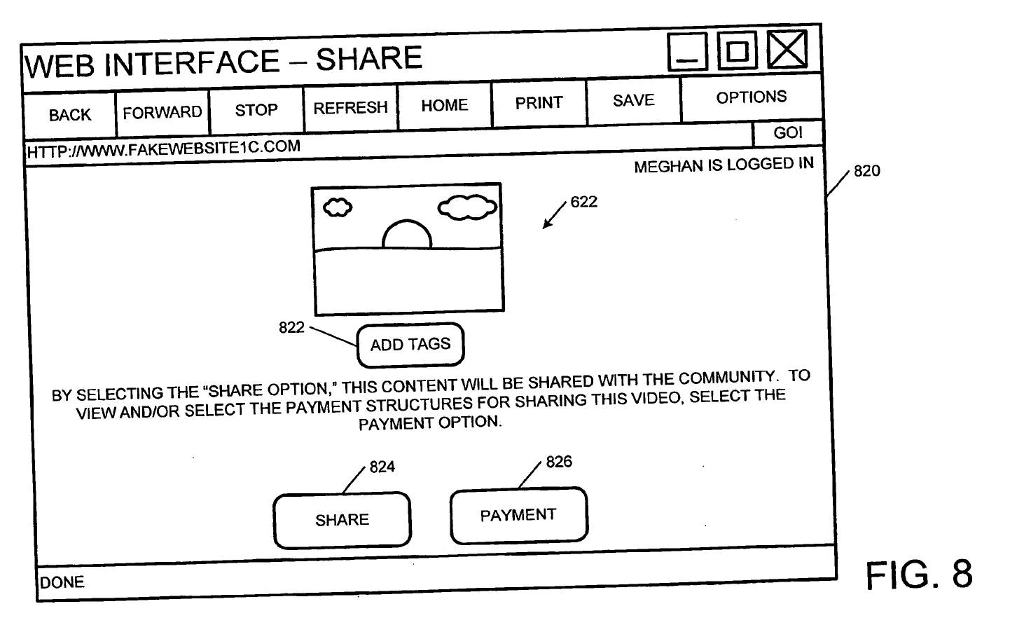

FIG. 8 illustrates a nonlimiting example of a user interface for providing an option to add one or more tags to uploaded content, similar to the interface from FIG. 7.

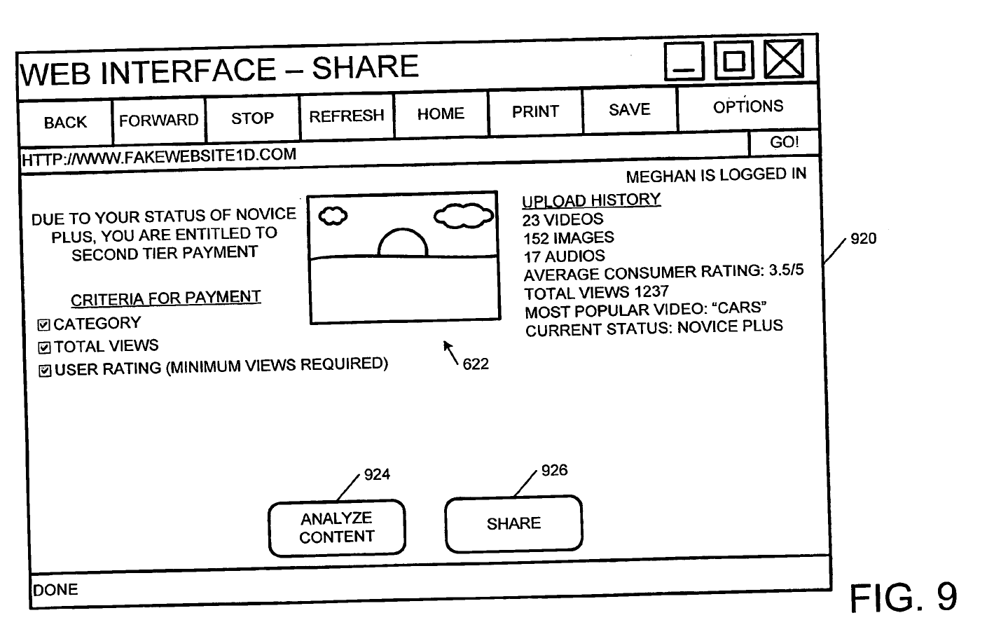

FIG. 9 illustrates a nonlimiting example of a user interface for providing share options for uploaded content, similar to the diagram from FIG. 8.

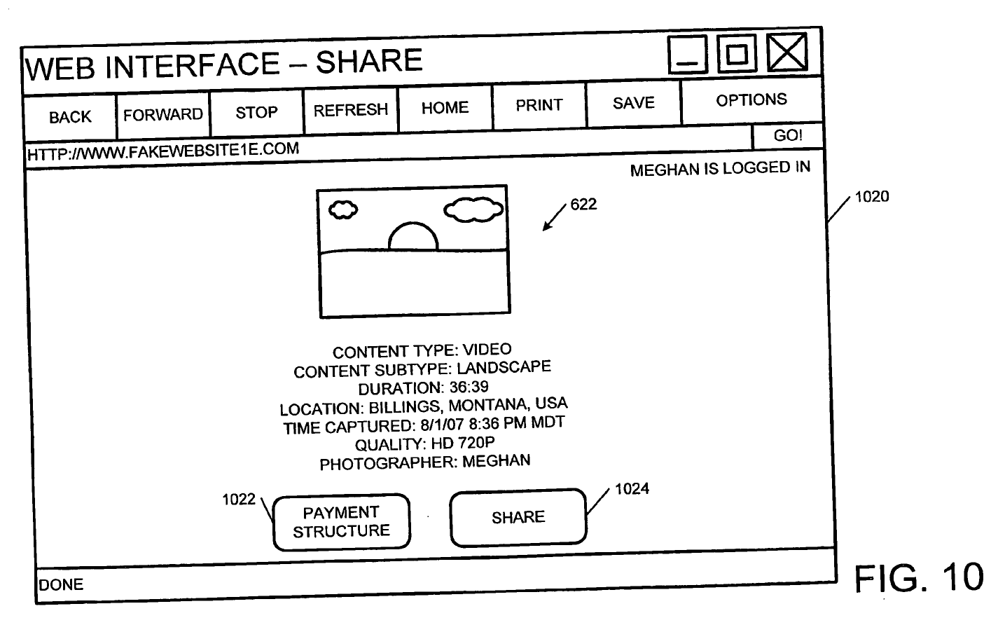

FIG. 10 illustrates a nonlimiting example of a user interface for providing content analysis data to a user, similar to the interface from FIG. 9.

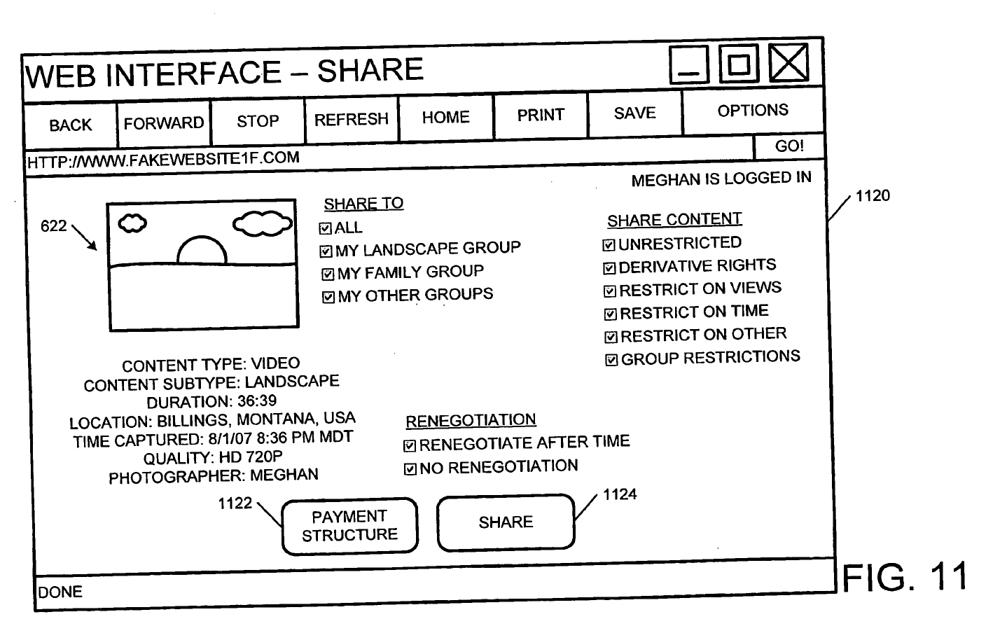

FIG. 11 illustrates a nonlimiting example of a user interface for providing one or more sharing options for uploaded content, similar to the interface from FIG. 10.

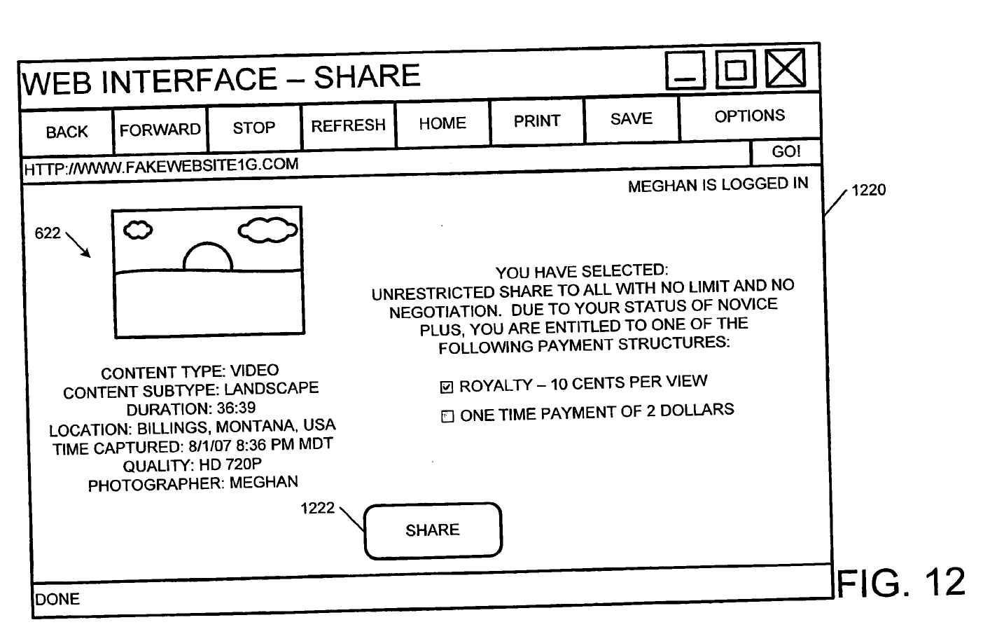

FIG. 12 illustrates a nonlimiting example of a user interface for providing one or more compensation options for sharing uploaded content, similar to the interface from FIG. 11.

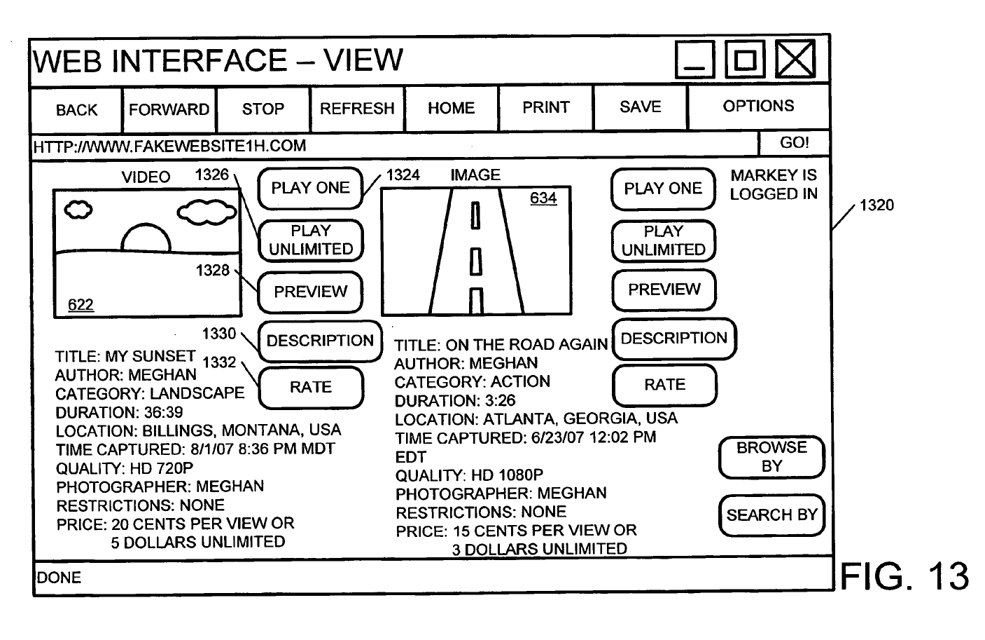

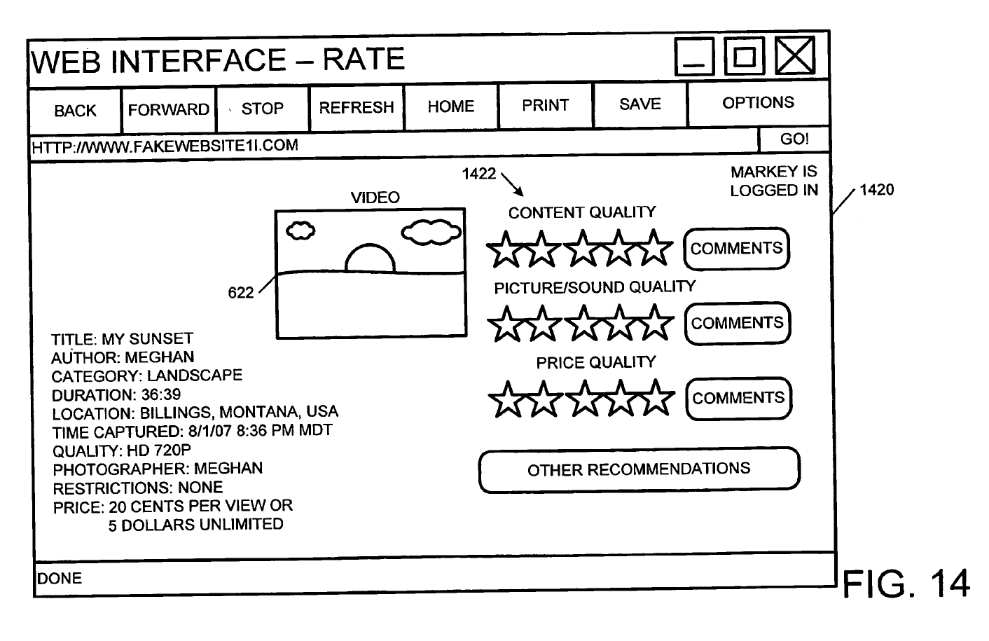

FIG. 13 illustrates a nonlimiting example of a user interface for providing uploaded content to a consumer, similar to the interface from FIG. 12.

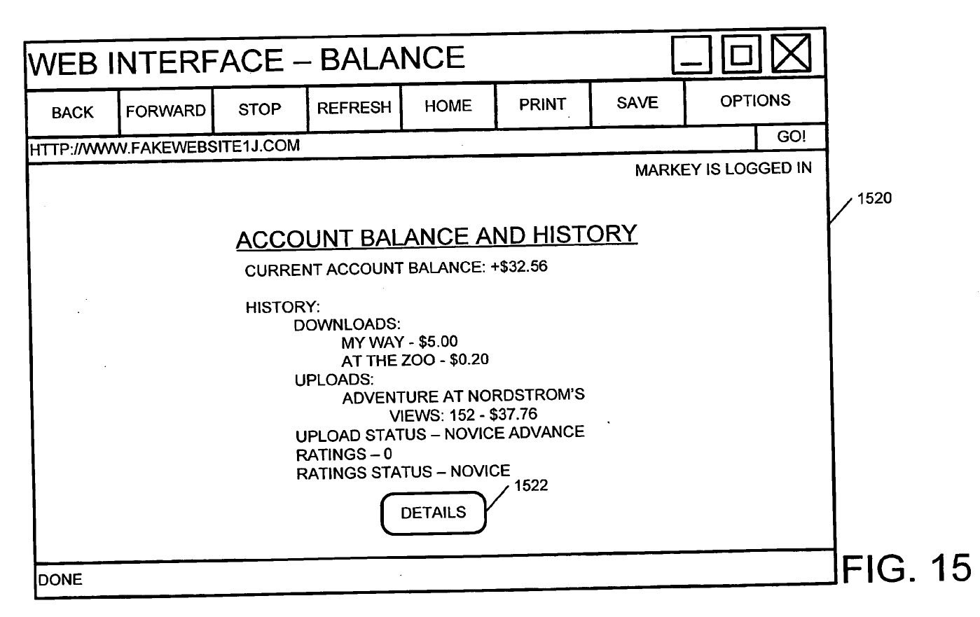

FIG. 14 illustrates a nonlimiting example of a user interface for providing one or more ratings options to a content rater, similar to the interface from FIG. 13.

FIG. 15 illustrates a nonlimiting example of a user interface for providing account balance data, similar to the interface from FIG. 14.

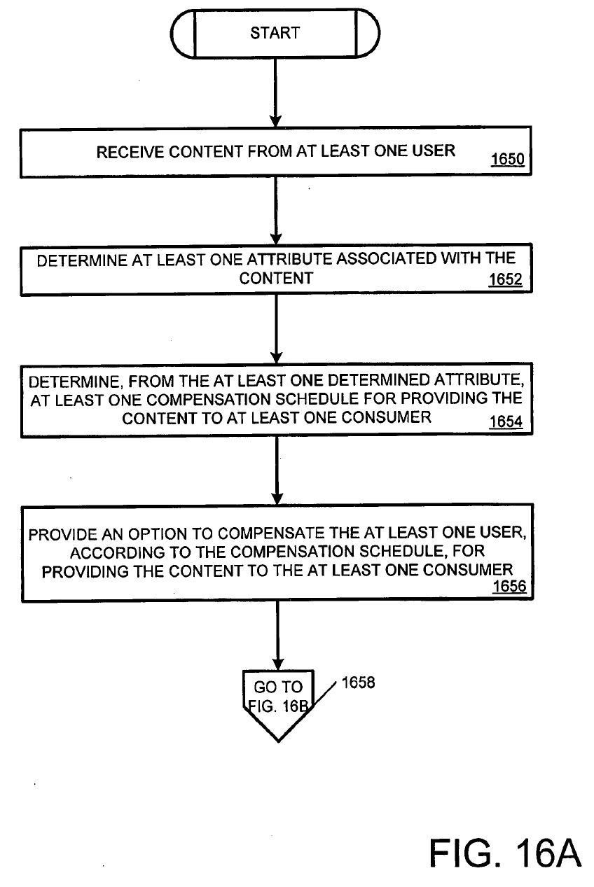

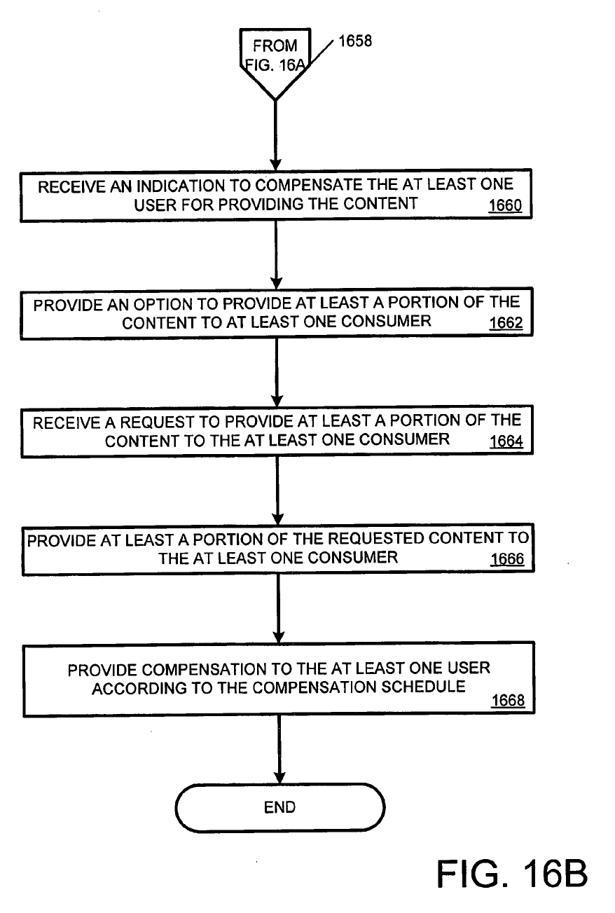

FIG. 16A is a flowchart illustrating an exemplary process that may be utilized in providing compensation to at least one user that uploaded data, such as in the network from FIG. 1.

FIG. 16B is a continuation of the flowchart from FIG. 16A.

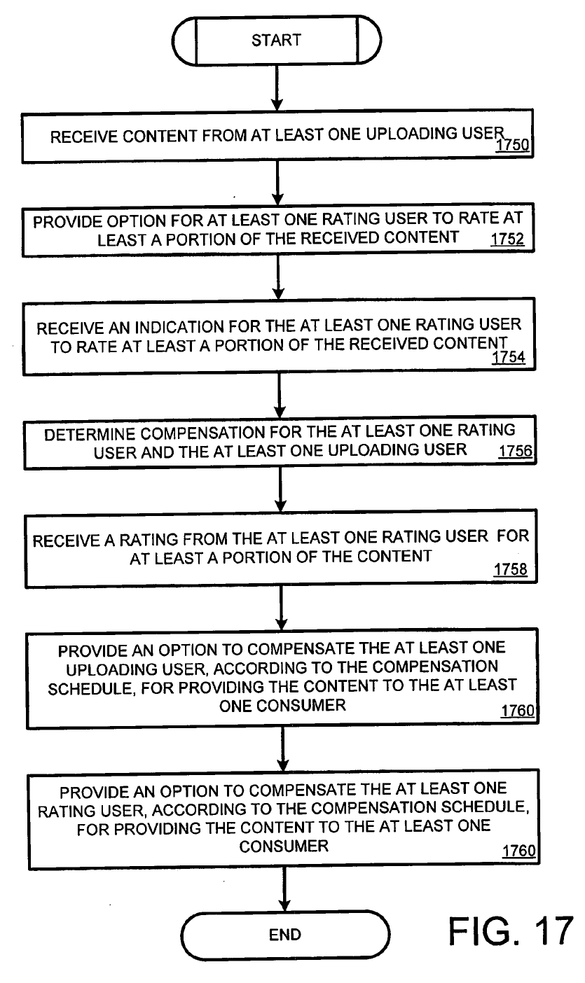

FIG. 17 is a flowchart illustrating an exemplary process that may be utilized for compensating at least one user according to received ratings, similar to the flowchart from FIGS. 16A and 16B.

### DETAILED DESCRIPTION

Embodiments disclosed herein may be configured to provide options for a structured compensation schedule for users to provide content to consumers. More specifically, in at least one exemplary embodiment, a user may upload data and agree to a structured compensation schedule that corresponds to the quality of past content uploaded by that user, the quality of the current content, access to the content granted by the user, and/or other criteria. Additionally, some embodiments may provide a compensation schedule for users to view uploaded content. The consumer compensation schedule may include charging a consumer based on time spent with content, the value of the content, the number of views, and/or other criteria. Similarly some embodiments may be configured to provide a compensation schedule for ratings users to rate uploaded content. Other embodiments may also be discussed.

Referring to the drawings, FIG. 1 illustrates a nonlimiting example of communications network, which may be configured to facilitate communication of content. More specifically, as illustrated in the nonlimiting example of FIG. 1, a network 100 may be utilized and include a Wide Area Network (WAN), such as the Internet, a Public Switched Telephone Network (PSTN), Mobile Communications Network (MCN) and/or other network. Similarly, the network 100 may include, a wireline and/or a wireless Local Area Network (LAN). Regardless of the communications medium and protocol, the network 100 may be coupled to a client device 102. The client device 102 may include a personal computer, laptop, or other device that is configured for communicating with the network 100. The client device 102 may also be coupled to a capture device 104. The capture device 104 may be configured to capture content (e.g., image data, audio data, video data, etc.). More specifically, a user can capture content via the capture device 104 and upload at least a portion of that content (and/or metadata associated with the content, such as the location the content was captured, time, duration, etc.) to the client device 102. The client device 102 may be configured to receive and/or store the data from the capture device 104.

The client device 102 may also be configured to upload at least a portion of the received content (and/or metadata) to a server 106. More specifically, the server 106 may be configured to provide a user interface for viewing, uploading, and/or downloading content. The upload user, via client device 102 can upload at least a portion of the received data to the server 106. Similarly, access to the uploaded content (and/or other data) may be provided to the client device 102 and other client devices via the server 106.

Also included in the nonlimiting example of FIG. 1 is a capture device 108, which is coupled to the network 100. More specifically, similar to the capture device 104, the capture device 108 may be configured to capture audio content, image content, video content, sensor content (e.g., a weather sensor, traffic sensor) and/or other data. However, the capture device 108 may be configured to communicate with the server 106 without use of the client device 102. More specifically, in this nonlimiting example, the capture device 108 may include software, hardware, and/or firmware for interfacing with the server 106 to upload content, download content, and/or view content.

Additionally included in the nonlimiting example of FIG. 1, is an access point 110. The access point may be configured as a wireless cellular tower, a Wireless Fidelity (Wi-Fi) hotspot, a Worldwide Interoperability for Microwave Access (WIMAX) tower, and/or other wireless node. The access point 110 may be configured to communicate with a capture device 112 to upload and/or download content, as described above.

One should note that while the capture device 104, 108, and 112 are illustrated as a video camera, a still camera, and a cellular telephone, respectively, these are nonlimiting examples. More specifically, a capture device 104, 108, 112 may be configured to capture sensor data, as discussed above. In at least one exemplary embodiment, the capture device 104, 108, 112 may be configured to capture sensor data, such as weather data (e.g., temperature, humidity, barometric pressure, air quality), traffic data, and/or other data.

FIG. 2 illustrates a nonlimiting example of a server 106, which may be configured to provide options for uploading and/or downloading content, such as in the network from FIG. 1. Although a wire-line device (e.g., a server) is illustrated, this discussion can be applied to wireless devices, as well. According to exemplary embodiments, in terms of hardware architecture, the server 106 includes a processor 282, a memory component 284, a display interface 294, data storage 295, one or more input and/or output (I/O) device interface(s) 296, and/or one or more network interfaces 298 that are communicatively coupled via a local interface 292. The local interface 292 can include, for example but not limited to, one or more buses and/or other wired or wireless connections. The local interface 292 may have additional elements, which are omitted for simplicity, such as controllers, buffers (caches), drivers, repeaters, and receivers to enable communications. Further, the local interface 292 may include address, control, and/or data connections to enable appropriate communications among the aforementioned components. The processor 282 may be a device for executing software, particularly software stored in the memory component 284. The processor 282 can include any custom made or commercially available processor, a central processing unit (CPU), an auxiliary processor among several processors associated with the server 106, a semiconductor based microprocessor (in the form of a microchip or chip set), a macroprocessor, and/or generally any device for executing software instructions.

The memory component 284 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 284 may incorporate electronic, magnetic, optical, and/or other types of storage media. One should note that the memory 284 can have a distributed architecture (where various components are situated remote from one another), but can be accessed by the processor 282.

The software in the memory 284 may include one or more separate programs, which may include an ordered listing of executable instructions for implementing logical functions. In the example of FIG. 2, the software in the memory component 284 may include the content logic 299, as well as an operating system 286. The operating system 286 may be configured to control the execution of other computer programs and provides scheduling, input-output control, file and data management, memory management, and communication control and related services.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 284, so as to operate properly in connection with the operating system 286.

The Input/Output devices that may be coupled to the system I/O Interface(s) 296 may include input devices, for example but not limited to, a keyboard, mouse, scanner, touch screen, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more of the network interfaces 298 for facilitating communication with one or more other devices. More specifically, network interface 298 may include any component configured to facilitate a connection with another device. While in some embodiments, among others, the server 106 can include the network interface 298 that includes a Personal Computer Memory Card International Association (PCMCIA) card (also abbreviated as “PC card”) for receiving a wireless network card, this is a nonlimiting example. Other configurations can include the communications hardware within the server 106, such that a wireless network card is unnecessary for communicating wirelessly. Similarly, other embodiments include the network interfaces 298 for communicating via a wired connection. Such interfaces may be configured with Universal Serial Bus (USB) interfaces, serial ports, and/or other interfaces.

If the server 106 includes a personal computer, workstation, or the like, the software in the memory 284 may further include a basic input output system (BIOS) (omitted for simplicity). The BIOS is a set of software routines that initialize and test hardware at startup, start the operating system 286, and support the transfer of data among the hardware devices. The BIOS is stored in ROM so that the BIOS can be executed when the server 106 is activated.

When the server 106 is in operation, the processor 282 may be configured to execute software stored within the memory component 284, to communicate data to and from the memory component 284, and to generally control operations of the server 106 pursuant to the software. Software in the memory component 284, in whole or in part, may be read by the processor 282, perhaps buffered within the processor 282, and then executed.

One should note that while the description with respect to FIG. 2 includes the server 106 as a single component, this is a nonlimiting example. More specifically, in at least one embodiment, the server 106 can include a plurality of servers, personal computers, telephones, and/or other devices. Similarly, while the description of FIG. 2 describes the server 106, this is also a nonlimiting example, as other components may also be included in this description.

Additionally, while the content logic 299 is illustrated in FIG. 2 as including a single software component, this is also a nonlimiting example. In at least one embodiment, the content logic 299 may include one or more components, embodied in software, hardware, and/or firmware. Additionally, while the content logic 299 is depicted as residing on a single device, such as server 106, the content logic 299 may include one or more components residing on one or more different devices.

The embodiments disclosed herein can be implemented in hardware, software, firmware, or a combination thereof. At least one embodiment disclosed herein is implemented in software and/or firmware that is stored in a memory and that is executed by a suitable instruction execution system. If implemented in hardware, as in an alternative embodiment, embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 3 is a flow diagram illustrating a nonlimiting example of interactions among an upload user 302, a service provider 304, and a content consumer 306, such as in the network from FIG. 1. As illustrated in the nonlimiting example of FIG. 3, the upload user 302 can upload content to a service provider 304. The service provider 304 may include one or more servers 106. However, regardless of the implementation, the service provider 304 may be configured to receive uploaded data from the upload user 302.

In response to receiving the uploaded data (and determining a compensation schedule, as discussed in more detail below), the service provider 304 can pay or provide compensation for the uploaded data. While in at least one the compensation can simply include cash and/or check, some embodiments may be configured such that the compensation may include credits for viewing and/or downloading other content from the service provider 304.

Similarly, a content consumer 306 may be configured to receive uploaded content for viewing from the service provider 304. In such a configuration, the content consumer 306 may be configured to access a website provided by the service provider 304 and send a request to view and/or download the uploaded content (and/or metadata). The content consumer 306 may be charged for this service via credit, a prepaid account, and/or via other payment schemes.

One should note that, while the upload user 302 and the content consumer 306 are illustrated in FIG. 3 as different entities, this is a nonlimiting example. More specifically, in at least one embodiment, the upload user 302 may also act as a content consumer 306 by viewing and/or downloading content that was uploaded from other sources. Similarly, a content consumer 306 can act as an upload user 302 by uploading content to the service provider 304. In such configurations, the compensation schedule may be configured such that an upload user 302 (and/or content consumer 306) can be compensated for uploaded content and charged for viewed/downloaded content.

FIG. 4 is a flow diagram illustrating a nonlimiting example of interactions among an upload user 402, a service provider 404, a content consumer 406, and a ratings user 408, similar to the diagram from FIG. 3. As illustrated in the nonlimiting example of FIG. 4, the upload user 402 can upload content to the service provider 404 and receive payment or compensation for the uploaded data. Similarly, the content consumer 406 can receive and/or download content from the service provider 404 in exchange for payment. Additionally the ratings user 408 may be configured to rate uploaded content for quality, entertainment, etc. The ratings user 408 can provide feedback of the uploaded content in exchange for payment and/or credit to view and/or download other content.

As discussed with FIG. 3, the ratings user 408 may be configured to upload content (e.g., operate as an upload user 402). Similarly, the ratings user 408 may be configured to view and/or download content (e.g., operate as a content consumer 406). As such, an appropriate compensation schedule for these actions may also be applied for the ratings user 408.

FIG. 5 illustrates a nonlimiting example of a user interface 520 for providing content to a consumer, such as in the network from FIG. 1. As illustrated in the nonlimiting example of FIG. 5, the web interface 520 may be configured to provide options for viewing, uploading, downloading, and rating content, as well as perform other actions. More specifically, the user interface 520 includes a my account option 522, a browse content option 524, a view agreement option 526, a search content by author option 528, a search content by subject option 530, and a rate content option 534.

More specifically, the my account option 522 may be configured to provide an uploading user 402, content consumer 406, and/or ratings user 408 (referred to collectively as the user) with information related to their account. The user 402, 406, 408 can create an account, to authenticate the user 402, 406, 408 for payment and charges made.

The browse content option 524 may be configured to provide the user 402, 406, 408 with uploaded content. The uploaded content may be organized into one or more categories.

The view agreement option 526 may be configured to provide the user 402, 406, 408 with specifics related to an agreement with the service provider 404. More specifically, the user 402, 406, 408 may enter into an agreement to provide compensation for sharing content, viewing content, downloading content, and/or rating content. Depending on the particular configuration, the agreement may be user specific, content specific, category specific, etc.

Similar to the browse content option 524, the search content by author option 528 and the search content by subject option 530 may be configured to provide uploaded content to a user 402, 406, 408. More specifically, the search options 528, 530 may be configured to provide the user with search functionality based on different criteria. While the nonlimiting example of FIG. 5 illustrated the search capabilities as including a search by author and a search by subject, other criteria may be included, such as a keyword search, a category search, etc.

The rate content option 534 may be configured to provide options related to rating uploaded content. More specifically, as discussed in more detail below, a ratings user 406 can rate uploaded content based on one or more criteria.

FIG. 6 illustrates a nonlimiting example of a user interface 620 for providing uploaded content to a user, similar to the interface from FIG. 5. As illustrated in the nonlimiting example of FIG. 6, the user interface 620 may be provided to a user 402, 406, 408 in response to selection of the my account option 522. Provided in the interface 620 is first uploaded content 622. Also included is an add tags option 624. The add tags option 624 may be configured to provide options for adding data to the content 622, such as location information, photographer information, content, title, author, and/or other data to complement the content 622. Similarly, an add effects option 626 is included and may be configured to provide options for adding effects to the content. More specifically, with video, the user 402, 406, 408 can add watermarks, and/or other video effects. If the content 622 includes audio, the add effects option 626 may be configured to provide audio effects. Similarly, if the content 622 includes image data, the add effects option 626 may be configured to provide imaging effects.

Also included is a view data option 628 for viewing data associated with the content 622. The data may include data added via the options 624, 626, however, other data may be viewed, as well. A delete option 632 may also be included to delete the content 622. A share option 630 may be included for sharing the content 622 with others. Also included is uploaded content 634. Similar options may be provided for the uploaded content 634, as discussed above.

A register new device option 646 may also be included, as well as a my settings option 648 and an upload option 650. The my settings option 648 may be configured to provide options specific to an account of the user 402, 406, 408. The upload option 650 may be configured to upload additional content. The register new device option 646 may be configured to facilitate registering a new capture device 104, 108, 112, as discussed in more detail below.

FIG. 7 illustrates a nonlimiting example of a user interface 720 for providing currently registered devices to a user, similar to the diagram from FIG. 6. As illustrated in the nonlimiting example of FIG. 7, the user interface 720 may be configured to provide data associated with registered capture devices 722 and 726. Also included are view specs options 724 and 728 for viewing data related to the capture devices 722 and 726, respectively. Additionally included are a register new device option 730 and a my settings option 732.

By registering a capture device 722, 726, a user 402, 406, 408 can facilitate upload from the capture device 722, 726 to the service provider 404. More specifically, in at least one embodiment, the capture devices 722, 726 may be configured to capture content. Additionally, upon registration, the capture devices 722, 726 may be configured to upload data to the service provider 404, such that the content is associated with the account of the user 402, 406, 408. Additionally, the capture device 722, 726 may be configured to determine other data, such as date, time, Global Positioning System (GPS) location, duration, audio quality, video quality, image quality, photographer, and/or other data. This data may be associated with the content and stored with the appropriate account.

Additionally, while not explicitly included in the exemplary embodiment of FIG. 7, a sensory capture device may be registered. As a nonlimiting example, a weather-sensing device (or other sensory device) may be registered. The sensory capture device may include a stand-alone device and/or may be incorporated into the capture device, as discussed above.

FIG. 8 illustrates a nonlimiting example of a user interface 820 for providing an option to add one or more tags to uploaded content, similar to the interface from FIG. 7. As illustrated in the nonlimiting example of FIG. 8, the user interface 820 may include the content 622, as well as an add tags option 822. The add tags option may be similar to the add tags option 624, from FIG. 6. Also included are a share option 824 and a payment option 826. The share option 824 may be configured to share the uploaded content 622 with the community, according to a predetermined compensation schedule agreement. If the user 402, 406, 408 does not currently have an applicable agreement, desires to review the current agreement, desires to change the current agreement, etc., the user may select the payment option 826.

FIG. 9 illustrates a nonlimiting example of a user interface 920 for providing share options for uploaded content, similar to the diagram from FIG. 8. As illustrated in the nonlimiting example of FIG. 9, the interface 920 includes the content 622. Also included is an indication of the user's current status as an upload user. More specifically, the service provider 404 may be configured to determine, based on previous actions, the level of payment to afford the upload user 402. As a nonlimiting example, if the upload user 402 has uploaded multiple videos with excellent quality that generates dozens of views and downloads, the service provider 404 may be apt to compensate the user more handsomely than a first time upload user. Similarly, other criteria may be considered when determining payment for a video and/or an upload user 402, such as category of content, user rating from other uploaded content, etc.

Also included are an analyze content option 924 and a share option 926. The share option 926 may be utilized for sharing the uploaded content 622, as discussed above. The analyze content option 924 may be utilized for analyzing the content 622, as discussed in more detail below.

FIG. 10 illustrates a nonlimiting example of a user interface 1020 for providing content analysis data to a user, similar to the interface from FIG. 9. As illustrated in the nonlimiting example of FIG. 10, the interface 1020 may be provided in response to selection of the analyze content option 924, from FIG. 9. More specifically, in response to selection of the analyze content option 924, the service provider 404 can analyze the uploaded content for one or more criteria. As a nonlimiting example, the service provider 404 can determine content type, content subtype, duration, location, date and time captured, quality, and/or other data.

Similarly, other determinations may be made that relate to information about the content. As a nonlimiting example, if a car wreck occurs at a certain location at a certain time and is reported, the service provider 404 can determine the location of the capture device 722, 726 when the content was captured and determine whether this content is associated with the car wreck.

One should note that, depending on the configuration, metadata can be analyzed from the contents of the image, audio video, and/or sensory data. Similarly, some metadata can simply be determined at the device and uploaded to the service provider 404. As a nonlimiting example, video can be analyzed to determine whether the data is a landscape, portrait, or other format. As another nonlimiting example, an indication that the received data is video data, the video duration and/or other data may be received metadata from the capture device.

Similarly, depending on the type of data received, different metadata may also be received an/or determined. As a nonlimiting example, audio data may be associated with metadata such as a determination of the classification of audio (e.g., country, rock, vocal), while sensory data may include metadata associated with a different classification (e.g., temperature, barometric pressure, humidity).

FIG. 11 illustrates a nonlimiting example of a user interface 1120 for providing one or more sharing options for uploaded content, similar to the interface from FIG. 10. As illustrated in the nonlimiting example of FIG. 11, the user interface 1120 may be configured to provide sharing options for the uploaded data 622. More specifically, the upload user 402 can determine with whom to share the uploaded content. As a nonlimiting example, the user 404, 406, 408 can determine to share the content to anyone with access to the service provider 404. Additionally, the upload user 402 may join one or more groups and share the uploaded content with those in that group.

Additionally, the user 402 can determine any limitations on access to the content 622. As a nonlimiting example, the user 402 can provide unrestricted access to the content. Similarly, the user can restrict access, such as by preventing the creation of derivative works from the content. The user 402 can restrict the number of times another user 406, 408 can view the content. The user 402 can restrict the amount of time another user 406, 408 can view the content. Additionally, the user 402 can place user specific and/or group specific restrictions on the content 622. Other restrictions may also be included.

Also included are renegotiation options. More specifically, upon determining information about the user 402, the content 622, and receiving the user selections, the service provider 404 can determine a compensation schedule for the content 622. The user can, however determine whether a renegotiation is desired at a later time, as well as determine the duration of the currently negotiated agreement.

A payment structure option 1122 and a share option 1124 are also included. The share option 1124 may be configured to share the uploaded content 622. The payment structure option 1122 may be configured to view the determined payment structure for the content 622, as discussed in more detail below.

FIG. 12 illustrates a nonlimiting example of a user interface 1220 for providing one or more compensation options for sharing uploaded content, similar to the interface from FIG. 11. As illustrated in the nonlimiting example of FIG. 12, the service provider 404 may be configured to determine the compensation schedule for the uploaded content 622. As discussed above, this determination can be made based on a plurality of factors. Additionally, an option may be provided to determine whether the payment is a one time payment and/or whether the payment includes a royalty, based on number of views, number of downloads, and/or other criteria. Also included is a share option 1222 for agreeing to the proposed compensation schedule.

FIG. 13 illustrates a nonlimiting example of a user interface 1320 for providing uploaded content to a consumer, similar to the interface from FIG. 12. As illustrated in the nonlimiting example of FIG. 13, the interface 1320 may be configured to provide content 622 and content 634 to a content consumer. As discussed above, the content consumer may agree to a payment schedule for viewing content. The agreement may be determined based on the content the user has previously viewed. Similarly, some embodiments may be configured to structure the agreement according to the type of content being viewed, the rating of the content, and/or other criteria.

As such, the interface 1320 may include a play one option 1324. The play one option 1324 may be configured to play the selected content 622 once. Depending on the particular embodiment, the price may be presented in the interface 1230, after selection of the play one option 1324 and/or at other times. Also included is a play unlimited option 1326. The play unlimited option may be configured to allow the content consumer 406 to download the content permanently and/or view the content without limitation. This option may be amended, if the uploading user 402 restricts access to uploaded content, as discussed with regard to FIG. 11.

Also included is a preview option 1328. The preview option may be configured to allow the content consumer 406 to preview the content prior to purchase. The description option 1330 may be configured to provide detailed description associated with the content 622. The rate option 1332 may be configured to provide ratings of the content 622 and/or allow the content consumer to rate the content 622. Similar options may be provided for the content 634.

FIG. 14 illustrates a nonlimiting example of a user interface 1420 for providing one or more ratings options to a content rater, similar to the interface from FIG. 13. As illustrated in the nonlimiting example of FIG. 14, a ratings user 408 may be provided options 1422 associated with the selected content 622. Additionally, as discussed above, the ratings user 408 may be compensated for providing the ratings. The compensation may vary according to the number of ratings the ratings user 408 has provided. Similarly, in some embodiments, the compensation may depend on the accuracy of the ratings user's ratings versus total views of the content, and/or other criteria.

While the ratings illustrated in interface 1420 may include content quality, picture/sound quality, and price quality, these are nonlimiting examples, as other criteria may be utilized for rating the content 622. Similarly, the ratings user 408 may provide additional information regarding the content 622.

FIG. 15 illustrates a nonlimiting example of a user interface 1520 for providing account balance data, similar to the interface from FIG. 14. As illustrated in the nonlimiting example of FIG. 15, the interface 1520 may be configured to provide account balance details for a user 402, 406, 408. The details may include current account balance, download history, upload history, rating history, as well as status for uploads, downloads, and ratings. Other information may also be provided. A details option 1522 may be configured to provide details to the information provided in the interface 1520.

Additionally, while not illustrated in FIG. 15, some embodiments may be configured to provide success feedback of uploaded content. More specifically, content may be uploaded and receive a certain level of success (e.g., views and/or downloads). The uploading user (and/or another user with derivative rights) may amend the content and receive another level of success. As the level of success may vary, the user 402, 406, 408 (as well as the service provider 404) can view the success based on the changing content (and/or other factors).

FIG. 16A is a flowchart illustrating an exemplary process that may be utilized in providing compensation to at least one user that uploaded data, such as in the network from FIG. 1. As illustrated in the nonlimiting example of FIG. 16A, the service provider 404 may be configured to receive content from at least one user (block 1650). The service provider 404 can determine at least one attribute associated with the received content (1652). The service provider 404 can determine, from the at least one determined attribute, at least one compensation schedule for providing the content to the at least one content consumer 406 (block 1654). The service provider 404 can provide an option to compensate the at least one uploading user 402, according to the compensation schedule, for providing the content to the at least one content consumer 406 (block 1656). The flowchart can then proceed to block 1658, continued in FIG. 16B.

FIG. 16B is a continuation of the flowchart from FIG. 16A. As illustrated, from block 1658, the service provider 404 can receive an indication to compensate the at least one upload user for providing the content (block 1660). The service provider 404 can provide an option to provide at least a portion of the content to at least one content consumer 406 (block 1662). The service provider 404 can receive a request to provide at least a portion of the content to the at least one content consumer 406 (block 1664). The service provider 404 can provide at least a portion of the requested content to the at least one content consumer 406 (block 1666). The service provider 404 can provide compensation to the at least one uploading user 402 according to the compensation schedule (block 1668).

FIG. 17 is a flowchart illustrating an exemplary process that may be utilized for compensating at least one user according to received ratings, similar to the flowchart from FIGS. 16A and 16B. As illustrated in the nonlimiting example of FIG. 17, the service provider 404 can receive content from at least one uploading user 402 (block 1750). The service provider 404 can provide an option for at least one rating user 408 to rate the at least a portion of the received content (block 1752). The service provider 404 can receive an indication for the at least one rating user 408 to rate at least a portion of the received content (block 1754). The service provider 404 can determine compensation for the at least one rating user 408 and the at least one uploading user 402 (block 1756). The service provider 404 can receive a rating from the at least one rating user 408 for at least a portion of the content (block 1758). The service provider 404 can provide an option to compensate the at least one uploading user 402 according to the compensation schedule, for providing the content to the at least one consumer (block 1760). The service provider 404 can provide an option to compensate the at least one rating user 408 according to the compensation schedule, for providing the content to the at least one consumer (block 1760).

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks might occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for providing dynamic media rights, comprising:
receiving content from at least one uploading user;
determining at least one attribute associated with the content;
determining at least one compensation schedule for providing the content to at least one content consumer; and
providing an option to compensate the at least one uploading user, according to the compensation schedule, for providing the content to the at least one content consumer,
wherein the compensation schedule is determined from the at least one attribute.

2. The method of claim 1, further comprising compensating the at least one uploading user according to the compensation schedule.

3. The method of claim 1, wherein the content includes at least one of the following: image data, audio data, video data, sensory data, and metadata.

4. The method of claim 1, wherein determining at least one attribute associated with the content includes analyzing the content to determine at least one of the following: time of capture, duration, location of capture, type of content, subtype of content, photographer, image quality, audio quality, and video quality.

5. The method of claim 1, wherein the at least one attribute is an attribute associated with the content.

6. The method of claim 1, wherein the at least one attribute is an attribute associated with the uploading user.

7. The method of claim 1, further comprising receiving at least one rating for the content.

8. A system for providing dynamic media rights, comprising:
a receiving component configured to receive content from at least one uploading user;
a first determining component configured to determine at least one attribute associated with the content;
a second determining component configured to determine at least one compensation schedule for providing the content to at least one content consumer; and
a providing component configured to provide an option to compensate the at least one uploading user, according to the compensation schedule, for providing the content to the at least one content consumer,
wherein the compensation schedule is determined from the at least one attribute.

9. The system of claim 8, further comprising a compensating component configured to compensate the at least one uploading user according to the compensation schedule.

10. The system of claim 8, wherein the content includes at least one of the following: image data, audio data, video data, sensory data, and metadata.

11. The system of claim 8, wherein the first determining component determines at least one attribute associated with the content by analyzing the content to determine at least one of the following: time of capture, duration, location of capture, type of content, subtype of content, photographer, image quality, audio quality, and video quality.

12. The system of claim 8, wherein the at least one attribute is an attribute associated with the content.

13. The system of claim 8, wherein the at least one attribute is an attribute of the uploading user.

14. The system of claim 8, wherein the receiving component further receives at least one rating for the content.

15. A computer readable storage medium for providing dynamic media rights, comprising:
receiving logic configured to receive content from at least one uploading user;
first determining logic configured to determine at least one attribute associated with the content;
second determining logic configured to determine at least one compensation schedule for providing the content to at least one content consumer; and
providing logic configured to provide an option to compensate the at least one uploading user, according to the compensation schedule, for providing the content to the at least one content consumer,
wherein the compensation schedule is determined from the at least one attribute.

16. The computer readable storage medium of claim 15, further comprising a compensating logic configured to compensate the at least one uploading user according to the compensation schedule.

17. The computer readable storage medium of claim 15, wherein the content includes at least one of the following: image data, audio data, video data, sensory data, and metadata.

18. The computer readable storage medium of claim 15, wherein the first determining logic determines at least one attribute associated with the content by analyzing the content to determine at least one of the following: time of capture, duration, location of capture, type of content, subtype of content, photographer, image quality, audio quality, and video quality.

19. The computer readable storage medium of claim 15, wherein the at least one attribute is an attribute associated with the content.

20. The computer readable storage medium of claim 15, wherein the at least one attribute is an attribute of the uploading user.
